(19) United States
(12) Patent Application Publication
(10) Pub. No.: US 2015/0006321 A1
(43) Pub. Date: Jan. 1, 2015

(54) ESTABLISHING LOCATION INFORMATION RELATED TO AREA, AISLE, SECTION, AND SHELF LAYOUT IN A RETAIL ENVIRONMENT

(71) Applicant: Thomas Michael Cozad, Seattle, WA (US)

(72) Inventor: Thomas Michael Cozad, Seattle, WA (US)

(21) Appl. No.: 14/321,498

(22) Filed: Jul. 1, 2014

Related U.S. Application Data
(60) Provisional application No. 61/841,816, filed on Jul. 1, 2013.

(51) Int. Cl. G06Q 10/08; G06K 7/10; G06Q 30/06

(52) U.S. Cl. CPC G06Q 10/087; G06Q 30/0639; G06K 7/10544; G06K 2007/10524
USPC 705/26.9; 705/26.1

(57) ABSTRACT

Techniques for managing product location information are described. Managing product location information may include generating store location information, including information that represents the layout of areas, aisles, sections, sides, and/or shelves within a given store or other establishment. Store location information can be used to represent the location of items within a given store. Some embodiments provide a mobile device configured to facilitate the generation of a store layout based on inputs received from a user who provides inputs regarding the areas, aisles, sides, sections, and shelves of the store.

### TECHNICAL FIELD

The present disclosure relates to methods, techniques, and systems for inventory management and, more particularly, to methods, techniques, and systems for establishing area/aisle-side-section location information related to the layout of a retail environment, thereby facilitating the generation of maps of the retail environment and/or the location-based tracking, search and discovery of items located in the retail environment.

### BACKGROUND

Many existing Point of Sale (“POS”) systems for retailers have fields to hold some values that represent location information for products available at a particular retail location, such as aisle or section number. Populating current POS with product location information systems is very slow and requires many steps and interactions with user screens. Moreover, current POS systems do not automatically produce a map of a retail location based on the input product location information. When a retailer does possess good product location information for their retail space, it greatly reduces labor cost related to tasks such as printing and hanging price tags, building pallets at the warehouse, and preparing signage and instructions for placing or finding products in the store.

### BRIEF DESCRIPTION OF THE DRAWINGS

FIG. 1 is an example block diagram illustrating the generation of store location information according to an example embodiment.

FIG. 2 is an example user interface screen for a mobile device configured to facilitate generation of store location information according to an example embodiment.

FIGS. 3.1-3.7 are example flow diagrams of store location information collection processes performed by example embodiments.

FIG. 4 is an example block diagram of an example computing system for implementing example embodiments.

FIGS. 5A-5C depict store navigation and product location information management user interface screens generated by scanning according to one embodiment.

### DETAILED DESCRIPTION

Embodiments described herein provide enhanced computer- and network-based methods and systems for inventory management and, more particularly, to methods, techniques, and systems for generating and establishing store location information, including information that represents the layout of areas, aisles, sections, sides, and/or shelves within a given store or other establishment. A section is typically a vertical stack of one or more shelves. Multiple sections are typically arranged side by side to form an aisle. Store location information can be used to represent the location of items (sometimes also called “products”) within a given store. While some of the described embodiments represent store location information at a highly granular level, including area, aisle, section, side, and shelf, other embodiments may exclude one or more of such fields, such as by not representing shelves, areas, or some other location indicator.

Example embodiments provide a mobile computing device (e.g., tablet computer, laptop computer, smart phone, smart scanner with UI) configured to efficiently input, select and generate store location information. In one embodiment, the mobile device or hand scanner receives an indication of an initial position in a store. The mobile device then records each area/aisle-side-section-shelf unique location and then receives an indication that the user has saved a combination of shelf counts that are in a given area/aisle-side.

### 1. Store Location Information Collection Overview

Gathering fine-grained location information about items in a particular store involves in some embodiments two distinct phases. In a first phase, which is the primary focus of this application, a user walks the store and collects store location information. The collected location information represents all or some of the possible locations at which products may be placed within the store. The collected location information can be used to generate a data structure that represents the layout of the store.

In the second phase, using the collected location information, the user again walks the store, this time collecting product location information that represents specific locations (e.g., area, aisle, side, section, and shelf) for each item in the store. Product location information is herein also sometimes referred to as product aisle location (“PAL”) information. Additional details related to this second phase and other techniques that may exploit the location information collected in the first phase may be found in U.S. patent application Ser. No. 13/713,962, filed Dec. 13, 2012 and entitled “SYSTEMS AND METHODS FOR MANAGING PRODUCT LOCATION INFORMATION,” which is incorporated herein by reference.

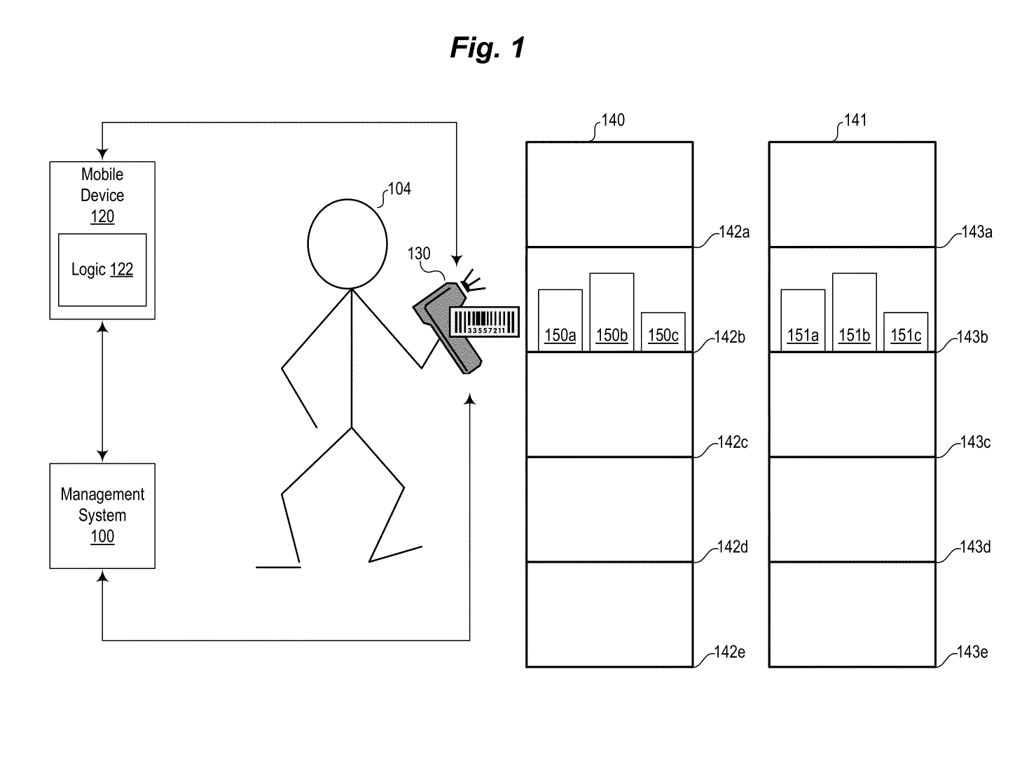

FIG. 1 is an example block diagram illustrating the generation of store location information according to an example embodiment. In particular, FIG. 1 shows a user 104 operating an interactive scanning device 130 (e.g., a bar code scanner) with or without the cooperation of a mobile device 120 to obtain area/aisle-side-section-shelf (“ASSS”) information for items 150a-150c and 151a-151c. The items 150 and 151 are arranged within respective shelving units 140 and 141 respectively comprising shelves 142a-142e and 143a-143e. The items 150 are located on shelf 142b, while the items 151 are located on shelf 143b. The mobile device 120 and the scanner device 130 includes logic 122 which may be an application or other module that is configured to perform the techniques described herein.

Beginning, in this example, with an area/aisle-side starting point, for example, the left end of aisle number 1, the user 104 specifies an initial position to the logic 122, such as by providing an indication of an area/aisle, and a side. In a user interface provided by the device 120, sections may be pre-numbered to provide placeholders for assigning the number of shelves in the corresponding sections. Then, the user 104, can identify and select the number of shelves in each section as he traverses the aisle. For example, for the first section 140, the user would enter 6 shelves (142a-142e). Then, the user would move to the second section 141 and again count and enter 6 shelves (143a-143e). This process is repeated until the end of the aisle is reached by the user 104.

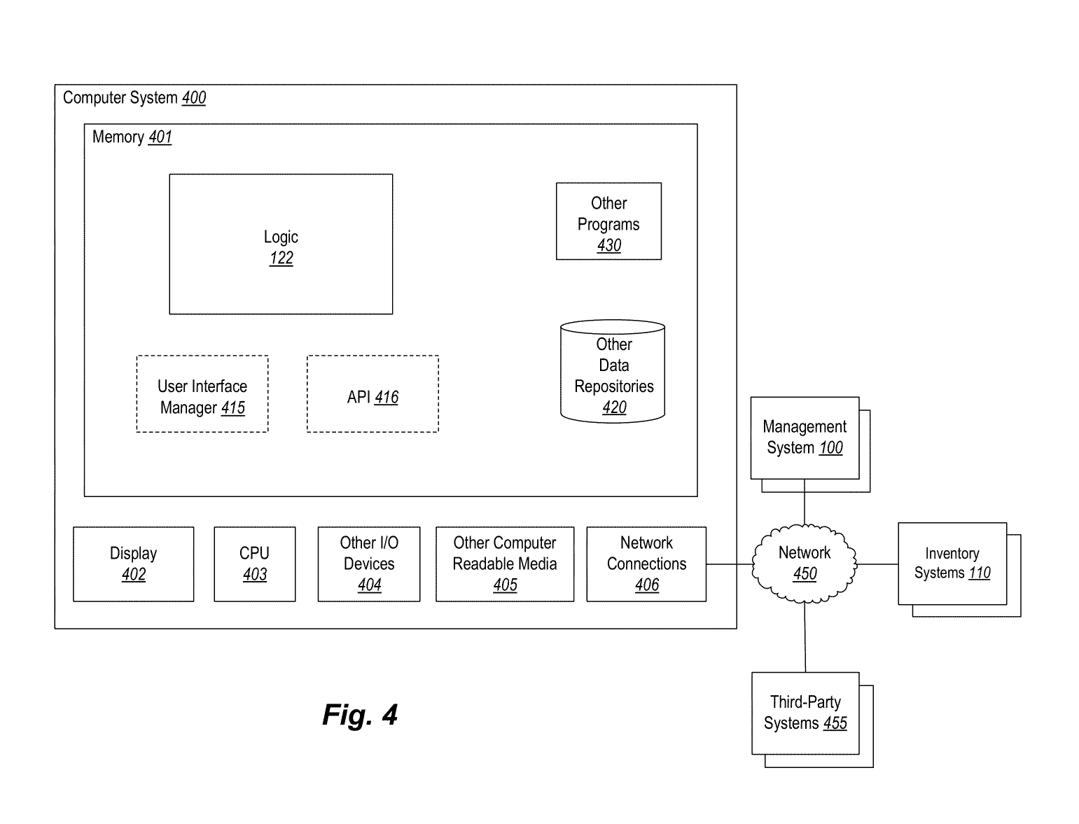

Note that the user does not have to follow any specific order in selecting shelves in 140 or 141, and sections can be left empty or unspecified if required, such as because no shelving units have been installed or for other reasons. When finished with the ASSS assignment for that location (e.g., aisle) selected by the user 104, they may save those entries by indicating such to the logic 122. In response, the logic 122 may automatically transmit the collected information to a store inventory system 110 (see FIG. 4) and/or a management system 100. The user 104 may then move to another area or aisle and continue to assign ASSS in that location till complete.

The management system 100 is a companion system to the logic 122 and may provide various services for the logic 122 and/or other clients. For example, the management system 100 may provide redundant storage capabilities for the mobile device 120. As another example, the management system 100 may provide a “virtual” store map based on information collected by the logic 122, so that the user 104 or some other operator can view, updated, and/or modify product location information for a given store, and then transmit any such changes to the store inventory system 110 or some other location.

In some embodiments, the management system 100 and/or the logic 122 may interact with a store inventory system (not shown). The store inventory system may be a point-of-sale system, a back office information system, a tracking system, a database, or the like. Typically, the store inventory system is located on or near the store premises, although it may also or instead be located remotely. The store inventory system will generally have its own format for storing location information, and the logic 122 may be configured to translate location information from one format (e.g., in which it is represented by the logic 122) to another format (e.g., in which it is represented by the store inventory system). FIG. 4 shows an example store inventory system 110.

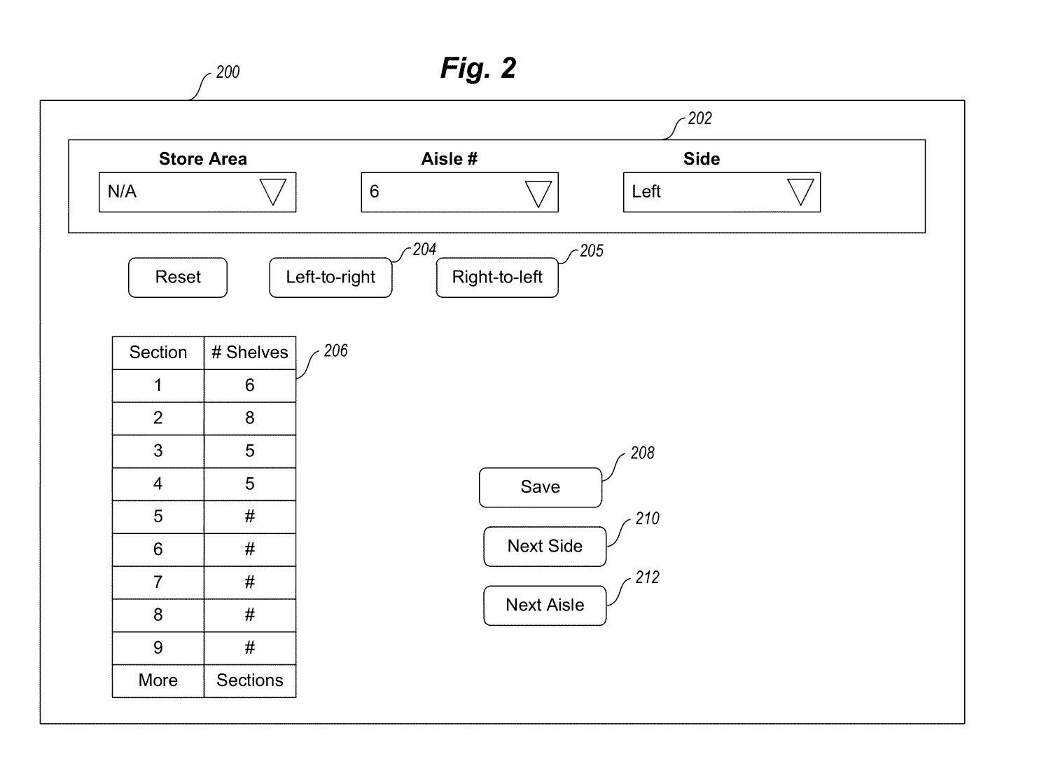

FIG. 2 is an example user interface screen for a mobile device configured to facilitate generation of store location information according to an example embodiment. The illustrated user interface facilitates the generation of area/aisle-side-section shelf counts in a retail location. In particular, FIG. 2 depicts a user interface screen 200 that may be displayed on the mobile device 120 or 130 by the logic 122.

The screen 200 includes a location identification section 202 that includes three controls (e.g., drop-down menus) that can be selected by a user to specify an initial position in the store. The menus include Store Area (e.g., produce, deli, bakery), Aisle Number, and Side of Aisle. In some cases, store area and aisle may be exclusive, such that only one or the other need be specified.

The screen 200 also includes a controls 204 and 205 that can be selected by the user to specify a data collection order of left to right or right to left. This enables corresponding sections across from each other in presentation.

The screen 200 further includes a table 206 that includes sections along with corresponding shelf counts for each section. The table 206 displays section number and shelves that are, or are not assigned (represented here by the “#” character), to a section. The table 206 also provides the user the ability to add new sections beyond the initial location inventory displayed.

The screen 200 also includes a Save Results control 208 that can be selected by the user to indicate the collection for the specified area/aisle is complete and that the user is ready to advance to a new location.

The screen 200 also includes a Next Side control 210 that can be selected by the user to indicate that the collection for the specified aisle side has been completed. Selecting control 210 also advances the “Side” setting in 202 to the opposite side of that area/aisle-side in the direction the user wants to advance, according to the selection of button 204 or 205.

The screen 200 also includes a Next Aisle control 212 that can be selected by the user to indicate that the collection for both sides of the specified aisle is complete. Selecting control 212 also advances both the “Side” setting in 202 to the opposite side and the Aisle Number (by one) so that the user does not have to engage those settings in the next aisle.

By way of example, the user may operate screen 200 to initially specify collection on the left side of aisle 1 in the store. The user then walks the aisle and enters shelf counts for the left side of aisle 1 into the table 206. Once complete with the left side, the user selects the next side button 210, which advances the side (in 202) to right, stores the entered data in table 206, and clears the table 206 for additional entry. The user then walks the aisle and enters shelf counts for the right side of aisle 1 into the table 206. Once complete with the right side of, the user selects the next aisle button 212, which advances the aisle (in 202) to 2, and sets the side (in 202) back to left. The user then travels to aisle 2, and repeats the above process.

The illustrated user interface includes numerous technical advantages. For example, the user need only make a single input (e.g., by clicking button 210 or 212) in order to advance the user interface configuration to receive shelf inputs for the next side of the aisle, or the next aisle in the store. Also, in some embodiments the mobile device that presents the user interface includes a speech recognition component that is configured to receive voice inputs, such as a series of numbers, uttered by the user as he walks from one end of the aisle to another. These voice inputs are then reflected in the table 206.

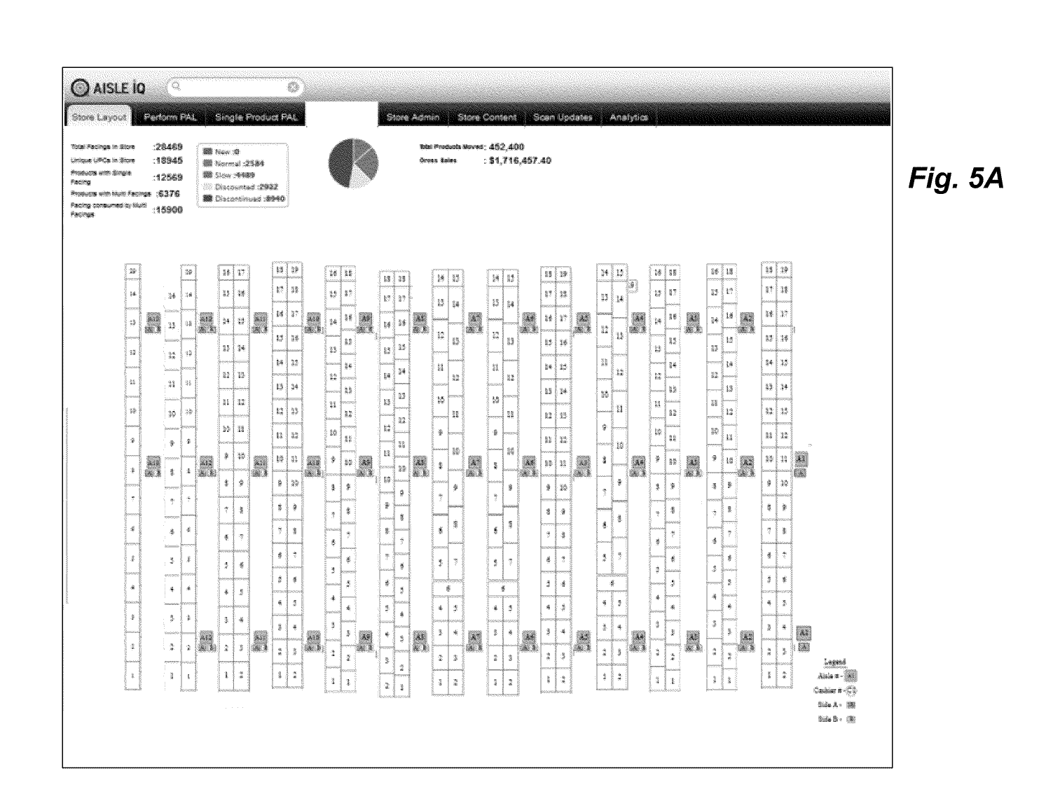

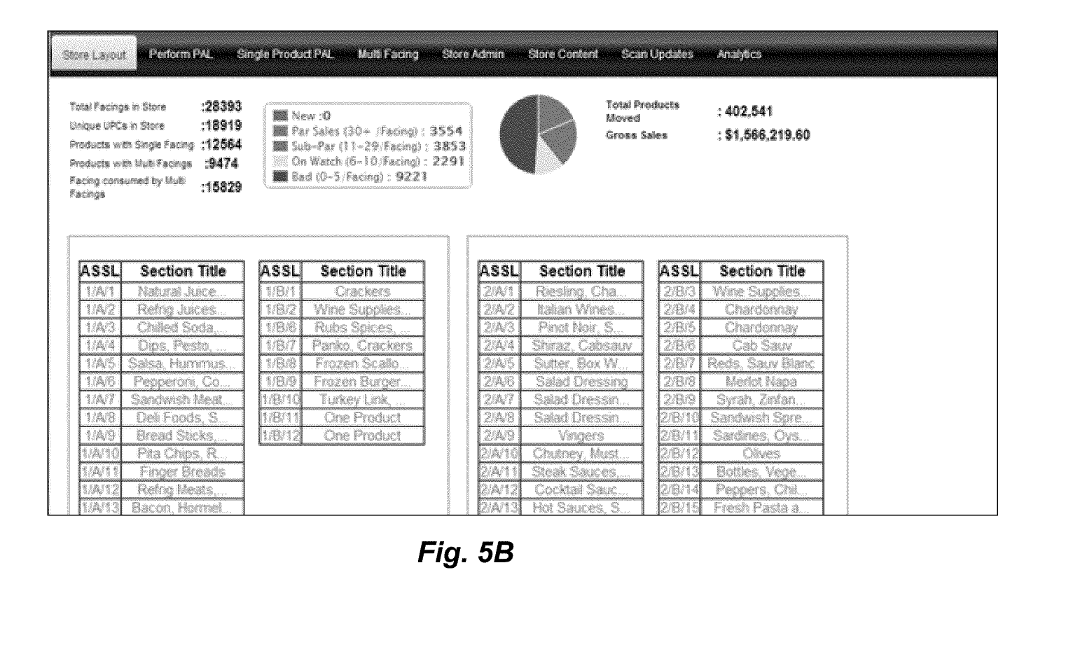

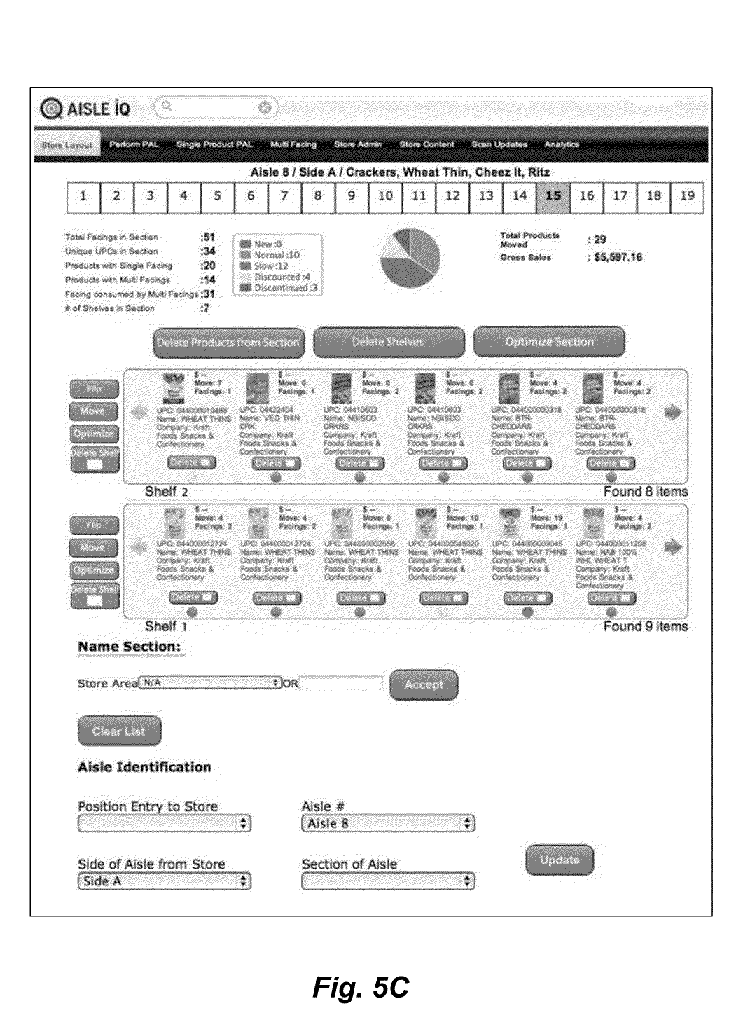

FIGS. 5A-5C depict store navigation and product location information management user interface screens that are generated by scanning according to one embodiment. By way of overview, FIGS. 5A and 5B depict example store layouts generated and presented by example embodiments. FIG. 5C depict example user interface screens configured to facilitate product location management at a finer-grained level, such as at the section, shelf, or item level. Such management is enabled and facilitated by the store location information gathering techniques described herein.

FIG. 5A depicts a “map” style layout that provides a graphical view of store aisles and sections. In contrast, FIG. 5B is a tabular layout that provides a textual view of store aisles and sections. Either or both of the illustrated layouts may be interactive, in that a user can select (e.g., click, touch) a portion of the layout (e.g., an aisle or section) in order to access a user interface configured to provide a more detailed level of navigation or browsing, such as an aisle, section, or shelf-level browser/navigator user interface described with respect to FIG. 35C, below. The map of FIG. 5A and the tabular layout of FIG. 5B are in this embodiment generated by scanning activities only, and does not require a human to draw or lay out a map or other representation.

FIG. 5C depicts an aisle/section-level navigation user interface. The illustrated user interface depicts the sections of a single aisle. Upon user selection of one of the sections, shelf information is dynamically presented. In the illustrated example, the products located on two shelves (shelf 1 and shelf 2) are displayed. The user interface also provides quantity information related to the selected section, such as the total number of facings, unique UPCs, number of single/multiple facings, and the like.

The user interface further provides color-coded movement information. The movement information can be used by a store manager to determine the sales effectiveness of particular products and/or their arrangements. The movement information identifies (numerically and by way of pie chart) how many products are new, moving normally, moving slowly, discounted, and discontinued. Total sales information for the selected section is also presented.

In this example, blue is used to indicate new products (e.g., for which there is insufficient data to make a determination), green is used to indicate normal products, brown is used to indicate slow products, yellow is used to indicate discounted products, and red is used to indicate discontinued products. What is considered “normal” or “slow” may be based on human specified ranges (e.g., between 10 and 30 units per month) and/or automatically determined ranges, such as within one standard deviation of an average (e.g., average of other products in the same product category, other products in the same or different stores, etc.). In some embodiments, a “heat map” of a section, aisle, or entire store may be generated, in order to graphically depict areas or regions of a store that are particularly high (e.g., colored red to indicate “hot”) or low (e.g., colored “blue” to indicate “cold”) revenue generators.

The user interface further includes controls for managing product information, such as by deleting products from the section, deleting shelves from the section, or optimizing the section. Optimizing the section may include automatically rearranging, adding, or removing products to improve the sales prospects for the section. For example, poor performing products may be moved to lower shelves or removed altogether.

The user interface also presents a section name, which may be manually entered or automatically determined. Automatically determining a section name may be based on the most frequently occurring product or product category in the section. Other approaches may include machine learning/classification, such as by using a Bayesian classifier or neural network to classify a section based on the products located there. These techniques may also be applied to determining the section names shown in FIG. 5B, above.

### 2. Example Processes

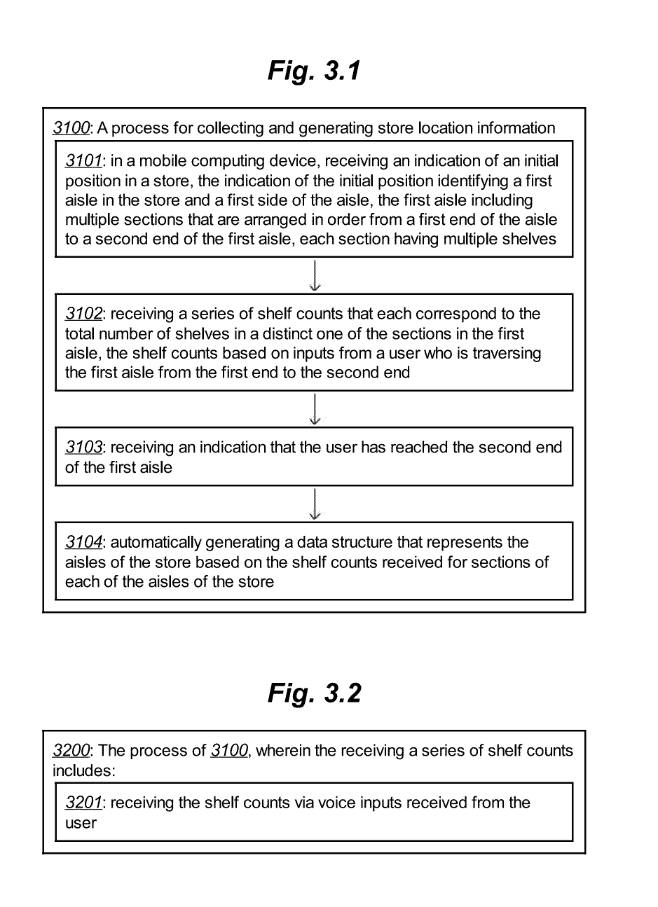

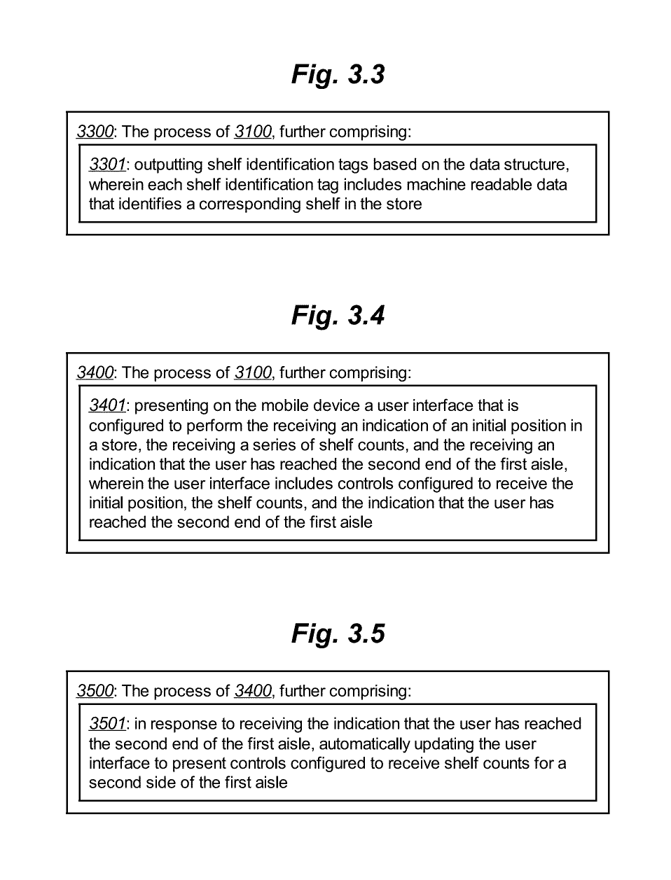

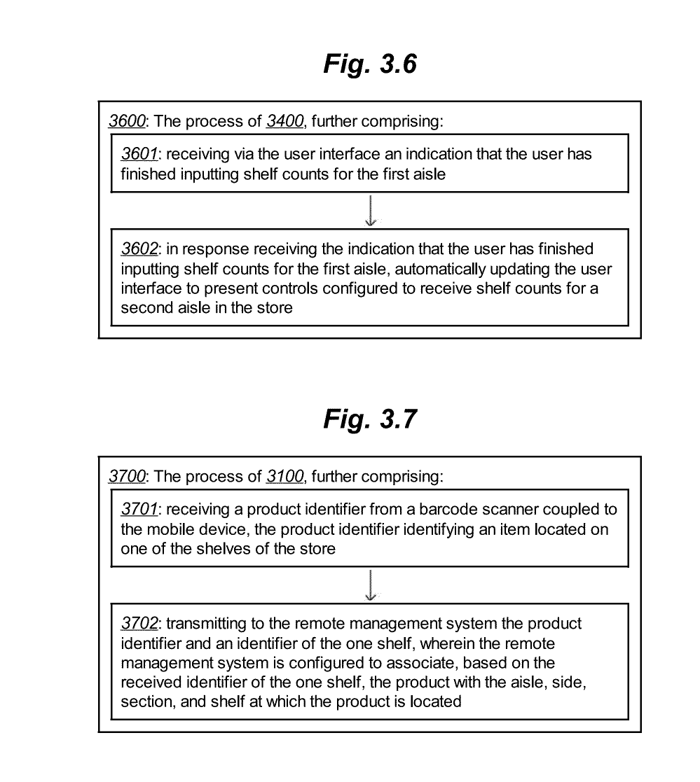

FIGS. 3.1-3.7 are example flow diagrams of store location information collection processes performed by example embodiments.

FIG. 3.1 is an example flow diagram of example logic for collecting and generating store location information. The illustrated logic in this and the following flow diagrams may be performed by, for example, the mobile device 120, the scanner 130, and/or the management system 100, described with respect to FIG. 1, above. More particularly, FIG. 3.1 illustrates a process 3100 that includes operations performed by or at the following block(s).

At block 3101, the process performs in a mobile computing device, receiving an indication of an initial position in a store, the indication of the initial position identifying a first aisle in the store and a first side of the aisle, the first aisle including multiple sections that are arranged in order from a first end of the aisle to a second end of the first aisle, each section having multiple shelves. The initial position typically includes aisle number and a side of the aisle (e.g., left or right). In some embodiments, the initial position may also or instead include an indication of store area (e.g., produce, canned goods, cleaning supplies, frozen foods). FIG. 2 provides an example user interface for providing this initial data.

At block 3102, the process performs receiving a series of shelf counts that each correspond to the total number of shelves in a distinct one of the sections in the first aisle, the shelf counts based on inputs from a user who is traversing the first aisle from the first end to the second end. Typically, a user will walk the aisle from one end to another, inputting the number of shelves per section, one after another. Once the user reaches one end, he will turn and proceed back to the other end. In other embodiments, the user may walk the aisle once, inputting shelf counts in an alternating left/right manner, such that the user need only walk the aisle once.

At block 3103, the process performs receiving an indication that the user has reached the second end of the first aisle. The user may press a button or make some other input to indicate that he has reached the end of the aisle.

At block 3104, the process performs automatically generating a data structure that represents the aisles of the store based on the shelf counts received for sections of each of the aisles of the store. Once the process has received shelf counts for the aisles of the store, the process can automatically generate a data structure that can serve as a placeholder for product location information and/or can be used to generate a map or layout of the store. Example store maps are shown in FIGS. 5A and 5B. The generated data structure or map may then or later be populated with product location information, such as by making a second pass of the store with a scanner that is used to read product identifiers (e.g., bar codes). In some embodiments, the process may use the data structure to print shelf tags, which may be attached to store shelves in order to facilitate the collection of product location information.

FIG. 3.2 is an example flow diagram of example logic illustrating an example embodiment of process 3100 of FIG. 3.1. More particularly, FIG. 3.2 illustrates a process 3200 that includes the process 3100, wherein the receiving a series of shelf counts includes operations performed by or at one or more of the following block(s).

At block 3201, the process performs receiving the shelf counts via voice inputs received from the user. In some embodiments, the user utters a sequence of numbers as he walks down the aisle, where each number corresponds to the number of shelves in a section. The mobile device or some remote processing unit (e.g., manager 100) includes a speech recognition unit to recognize the voice inputs, and to transfer text corresponding to the utterance to the logic 122 and/or the displayed user interface.

FIG. 3.3 is an example flow diagram of example logic illustrating an example embodiment of process 3100 of FIG. 3.1. More particularly, FIG. 3.3 illustrates a process 3300 that includes the process 3100, and which further includes operations performed by or at the following block(s).

At block 3301, the process performs outputting shelf identification tags based on the data structure, wherein each shelf identification tag includes machine readable data that identifies a corresponding shelf in the store. The process may initiate the printing or other output of shelf identification tags. Each shelf tag identifies a corresponding store shelf, such as by way of a bar code or other machine readable representation. The shelf tags may then be attached at or near their corresponding store shelves, in order to facilitate subsequent collection of product location information. Additional details regarding the use of shelf tags are provided in U.S. patent application Ser. No. 13/713,962, filed Dec. 13, 2012 and entitled “SYSTEMS AND METHODS FOR MANAGING PRODUCT LOCATION INFORMATION.”

FIG. 3.4 is an example flow diagram of example logic illustrating an example embodiment of process 3100 of FIG. 3.1. More particularly, FIG. 3.4 illustrates a process 3400 that includes the process 3100, and which further includes operations performed by or at the following block(s).

At block 3401, the process performs presenting on the mobile device a user interface that is configured to perform the receiving an indication of an initial position in a store, the receiving a series of shelf counts, and the receiving an indication that the user has reached the second end of the first aisle, wherein the user interface includes controls configured to receive the initial position, the shelf counts, and the indication that the user has reached the second end of the first aisle. An example user interface is described with reference to FIG. 2. The user interface is typically displayed on a mobile device, such as a tablet computer that is carried by the user.

FIG. 3.5 is an example flow diagram of example logic illustrating an example embodiment of process 3400 of FIG. 3.4. More particularly, FIG. 3.5 illustrates a process 3500 that includes the process 3400, and which further includes operations performed by or at the following block(s).

At block 3501, the process performs in response to receiving the indication that the user has reached the second end of the first aisle, automatically updating the user interface to present controls configured to receive shelf counts for a second side of the first aisle. Updating the user interface may include toggling the aisle side (e.g., from left to right or right to left), presenting placeholders or other input controls that are configured to receive shelf counts for the second side of the aisle, and the like. At this time, the data entered for the first side of the aisle may also be stored, such as locally on the mobile device and/or by transmitting the shelf data to a remote management system.

FIG. 3.6 is an example flow diagram of example logic illustrating an example embodiment of process 3400 of FIG. 3.4. More particularly, FIG. 3.6 illustrates a process 3600 that includes the process 3400, and which further includes operations performed by or at the following block(s).

At block 3601, the process performs receiving via the user interface an indication that the user has finished inputting shelf counts for the first aisle. As shown in FIG. 2, the user interface may include a button that can be selected by the user to indicate that entry for the first aisle has been completed.

At block 3602, the process performs in response receiving the indication that the user has finished inputting shelf counts for the first aisle, automatically updating the user interface to present controls configured to receive shelf counts for a second aisle in the store. Updating the user interface may include advancing (or decrementing) the aisle number (e.g., advancing the aisle from n to n+1), toggling the aisle side indicator (e.g., from right to left), and presenting input controls that are configured to receive shelf counts for the first side of the next aisle to be processed. At this time, data entered for the aisle (e.g., both the first and second side, or just the second side) may be stored locally on the client device and/or remotely on a management system.

FIG. 3.7 is an example flow diagram of example logic illustrating an example embodiment of process 3100 of FIG. 3.1. More particularly, FIG. 3.7 illustrates a process 3700 that includes the process 3100, and which further includes operations performed by or at the following block(s).

At block 3701, the process performs receiving a product identifier from a barcode scanner coupled to the mobile device, the product identifier identifying an item located on one of the shelves of the store. As discussed above, in a second phase of operation, a user may walk the store using the mobile device and a scanner (or other input) to scan products on shelves, so that location information can be associated with those products.

At block 3702, the process performs transmitting to the remote management system the product identifier and an identifier of the one shelf, wherein the remote management system is configured to associate, based on the received identifier of the one shelf, the product with the aisle, side, section, and shelf at which the product is located. The mobile device transmits the product identifier (e.g., from a scanned barcode) and a shelf identifier to the remote management system, where an association between the location and the product can be stored. As noted above, the shelf identifier may be determined by way of scannable shelf tag or by other means, such as user input.

Other processes are contemplated. In one embodiment, the process performs, in a mobile computing device 120 or scanner 130, receiving an indication of an initial position in a location, the indication of the initial position identifying an area/aisle-side that includes multiple sections arranged in order from a first end of the area/aisle-side to a second end area/aisle-side. The initial position may include other information, including store area, store aisle, side.

The process then performs receiving a series of shelf identifiers that each correspond to a section received from the user who is traversing the area/aisle-side location the first end to the second end. Typically, a user will enter shelf counts in a section in sequence (e.g., from left to right). As each shelf count number entered, the mobile device will receive the identifiers for each entry made by the user and save.

The process then performs receiving an indication that the user has reached the second end of the area/aisle-side-section. The user may press a button or make some other input to indicate that he has reached the end of the location set.

### 3. Example Computing System Implementation

FIG. 4 is an example block diagram of an example computing system for implementing example embodiments. In particular, FIG. 4 shows a computing system 400 that may be utilized to implement the logic 122 and/or the management system 100 described with respect to FIG. 1.

Note that one or more general purpose or special purpose computing systems/devices may be used to implement the logic 122. In addition, the computing system 400 may comprise one or more distinct computing systems/devices and may span distributed locations. Furthermore, each block shown may represent one or more such blocks as appropriate to a specific embodiment or may be combined with other blocks. Also, the logic 122 may be implemented in software, hardware, firmware, or in some combination to achieve the capabilities described herein.

In the embodiment shown, computing system 400 comprises a computer memory (“memory”) 401, a display 402, one or more Central Processing Units (“CPU”) 403, Input/Output devices 404 (e.g., keyboard, mouse, CRT or LCD display, and the like), other computer-readable media 405, and network connections 406. The logic 122 is shown residing in memory 401. In other embodiments, some portion of the contents, some or all of the components of the logic 122 may be stored on and/or transmitted over the other computer-readable media 405. The components of the logic 122 preferably execute on one or more CPUs 403 and recommend content items, as described herein. Other code or programs 430 (e.g., an administrative interface, a Web server, and the like) and potentially other data repositories, such as data repository 420, also reside in the memory 401, and preferably execute on one or more CPUs 403. Of note, one or more of the components in FIG. 4 may not be present in any specific implementation. For example, some embodiments may not provide other computer readable media 405 or a display 402.

The logic 122 interacts via the network 450 with the management system 100, inventory systems 110, and third-party systems/applications 455. The network 450 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The third-party systems/applications 455 may include any systems that provide data to, or utilize data from, the logic 122 and/or the management system 100, including Web browsers, e-commerce sites, supply chain systems, and the like.

The logic 122 is shown executing in the memory 401 of the computing system 400. Also included in the memory are a user interface manager 415 and an application program interface (“API”) 416. The user interface manager 415 and the API 416 are drawn in dashed lines to indicate that in other embodiments, functions performed by one or more of these components may be performed externally to the logic 122.

The UI manager 415 provides a view and a controller that facilitate user interaction with the logic 122 and its various components. For example, the UI manager 415 may provide interactive access to the logic 122, such that users can interact with the logic 122 as described with respect to FIG. 2, above. In some embodiments, access to the functionality of the UI manager 415 may be provided via a Web server, possibly executing as one of the other programs 430. In such embodiments, a user operating a Web browser executing on one of the client devices 120 can interact with the logic 122 via the UI manager 415.

The API 416 provides programmatic access to one or more functions of the logic 122. For example, the API 416 may provide a programmatic interface to one or more functions of the logic 122 that may be invoked by one of the other programs 430 or some other module. In this manner, the API 416 facilitates the development of third-party software, such as user interfaces, plug-ins, adapters (e.g., for integrating functions of the logic 122 into Web applications), and the like.

In addition, the API 416 may be in at least some embodiments invoked or otherwise accessed via remote entities, such as code executing on the management system 100, one of the inventory systems 110, and/or one of the third-party systems/applications 455, to access various functions of the logic 122. For example, the management system 100 may push previously stored location information to the logic 122 via the API 416. The API 416 may also be configured to provide widgets (e.g., code modules) that can be integrated into the third-party applications 455 and that are configured to interact with the logic 122 to make at least some of the described functionality available within the context of other applications (e.g., mobile apps).

In an example embodiment, components/modules of the logic 122 are implemented using standard programming techniques. For example, the logic 122 may be implemented as a “native” executable running on the CPU 403, along with one or more static or dynamic libraries. In other embodiments, the logic 122 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the logic 122, such as in the data store 420, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 420 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the logic 122 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications, non-patent publications, and appendixes referred to in this specification and/or listed in the Application Data Sheet, including but not limited to U.S. patent application Ser. No. 13/713,962, filed Dec. 13, 2012 and entitled “SYSTEMS AND METHODS FOR MANAGING PRODUCT LOCATION INFORMATION,” and U.S. Provisional Patent Application No. 61/841,816, filed on Jul. 1, 2013 and entitled “ESTABLISHING AREA/AISLE SIDE SECTION SHELF LOCATIONS IN RETAIL ENVIRONMENTS,” are incorporated herein by reference, in their entireties.

From the foregoing it will be appreciated that, although specific embodiments have been described herein for purposes of illustration, various modifications may be made without deviating from the spirit and scope of this disclosure. For example, the methods, techniques, and systems for store aisle location information gathering are applicable to other architectures or in other settings. For example, instead of collecting information about the location of products on store shelves, at least some of the techniques may be employed to collect information about the location of books in a library or items stored in a warehouse. Also, the methods, techniques, and systems discussed herein are applicable to differing protocols, communication media (optical, wireless, cable, etc.) and devices (e.g., desktop computers, wireless handsets, electronic organizers, personal digital assistants, tablet computers, portable email machines, game machines, pagers, navigation devices, etc.).

1. A method for collecting and generating store location information, the method comprising:
in a mobile computing device, receiving an indication of an initial position in a store, the indication of the initial position identifying a first aisle in the store and a first side of the aisle, the first aisle including multiple sections that are arranged in order from a first end of the aisle to a second end of the first aisle, each section having multiple shelves;
receiving a series of shelf counts that each correspond to the total number of shelves in a distinct one of the sections in the first aisle, the shelf counts based on inputs from a user who is traversing the first aisle from the first end to the second end;
receiving an indication that the user has reached the second end of the first aisle; and
automatically generating a data structure that represents the aisles of the store based on the shelf counts received for sections of each of the aisles of the store.

2. The method of claim 1, wherein the receiving a series of shelf counts includes: receiving the shelf counts via voice inputs received from the user.

3. The method of claim 2, wherein the receiving the shelf counts via voice inputs received from the user includes: receiving a series of numbers uttered by the user as the user walks from the first end of the first aisle to the second end of the first aisle.

4. The method of claim 1, further comprising: outputting shelf identification tags based on the data structure, wherein each shelf identification tag includes machine readable data that identifies a corresponding shelf in the store.

5. The method of claim 1, further comprising: presenting on the mobile device a user interface that is configured to perform the receiving an indication of an initial position in a store, the receiving a series of shelf counts, and the receiving an indication that the user has reached the second end of the first aisle, wherein the user interface includes controls configured to receive the initial position, the shelf counts, and the indication that the user has reached the second end of the first aisle.

6. The method of claim 5, further comprising: in response to receiving the indication that the user has reached the second end of the first aisle, automatically updating the user interface to present controls configured to receive shelf counts for a second side of the first aisle.

7. The method of claim 5, further comprising:
receiving via the user interface an indication that the user has finished inputting shelf counts for the first aisle; and
in response receiving the indication that the user has finished inputting shelf counts for the first aisle, automatically updating the user interface to present controls configured to receive shelf counts for a second aisle in the store.

8. The method of claim 5, further comprising: receiving via the user interface an indication of an area of the store.

9. The method of claim 5, further comprising:
receiving only a single input from the user that indicates that the user has reached the second end of the first aisle or that the user has finished inputting shelf counts for the first aisle; and
in response to the received single input, automatically updating the user interface to receive shelf counts for the second side of the first aisle or a second aisle in the store.

10. The method of claim 1, further comprising: transmitting the shelf counts for storage by a remote management system, wherein the remote management system is configured to generate the data structure and to generate a map of the store based on the data structure.

11. The method of claim 1, further comprising:
receiving a product identifier from a barcode scanner coupled to the mobile device, the product identifier identifying an item located on one of the shelves of the store; and
transmitting to the remote management system the product identifier and an identifier of the one shelf, wherein the remote management system is configured to associate, based on the received identifier of the one shelf, the product with the aisle, side, section, and shelf at which the product is located.

12. A system for collecting and generating store location information, the system comprising:
a processor;
a memory; and
a module that is stored in the memory and that is configured, when executed by the processor, to:
receive an indication of an initial position in a store, the indication of the initial position identifying a first aisle in the store and a first side of the aisle, the first aisle including multiple sections that are arranged in order from a first end of the aisle to a second end of the first aisle, each section having multiple shelves;
receive a series of shelf counts that each correspond to the total number of shelves in a distinct one of the sections in the first aisle, the shelf counts based on inputs from a user who is traversing the first aisle from the first end to the second end;
receive an indication that the user has reached the second end of the first aisle; and
in response to the received indication that the user has reached the second end of the first aisle, automatically transmit the shelf counts to a remote management system that is configured to generate a data structure that represents the aisles of the store based on the shelf counts received for sections of each of the aisles of the store.

13. The system of claim 12, further comprising:
a user interface that is presented by the module, the user interface including controls configured to receive the initial position, the shelf counts, and the indication that the user has reached the second end of the first aisle, and the user interface configured to:
in response to the received indication that the user has reached the second end of the first aisle, automatically update the user interface to present controls configured to receive shelf counts for a second side of the first aisle;
receive via the user interface an indication that the user has finished inputting shelf counts for the first aisle; and
in response the received indication that the user has finished inputting shelf counts for the first aisle, automatically update the user interface to present controls configured to receive shelf counts for a second aisle in the store.

14. The system of claim 13, wherein the user interface is further configured to:
receive only a single input from the user that indicates that the user has reached the second end of the first aisle or that the user has finished inputting shelf counts for the first aisle; and
in response to the received single input, automatically update the user interface to receive shelf counts for the second side of the first aisle or a second aisle in the store.

15. The system of claim 13, wherein the user interface is further configured to: present section identifiers that each have a corresponding entry field for a number of shelves.

16. The system of claim 12, further comprising: the remote management system, wherein the remote management system is further configured to associate location information with products located on shelves of the store.

17. The system of claim 12, wherein the memory is part of a mobile device coupled to a barcode scanner, and the module is configured to:
receive a product identifier from the barcode scanner, the product identifier identifying an item located on one of the shelves of the store; and
transmit to the remote management system the product identifier and an identifier of the one shelf, wherein the remote management system is configured to associate, based on the received identifier of the one shelf, the product with the aisle, side, section, and shelf at which the product is located.

18. A non-transitory computer-readable medium including contents that are configured, when executed, to cause a computing system to perform a method for collecting and generating store location information, the method comprising: performing the method of claim 1.

19. The computer-readable medium of claim 18, wherein the computer-readable medium is a memory in a mobile computing device, and wherein the contents include instructions that, when executed, cause the mobile computing device to perform the method.

20. The computer-readable medium of claim 18, wherein the method further comprises:
presenting a user interface that is configured to:
receive a series of inputs that each indicate a corresponding one of the shelf counts in the series of shelf counts;
receive only a single input from the user that indicates that the user has reached the second end of the first aisle or that the user has finished inputting shelf counts for the first aisle; and
in response to the received single input, automatically update the user interface to receive shelf counts for the second side of the first aisle or a second aisle in the store.
